(19) United States
(12) Patent Application Publication
(10) Pub. No.: US 2026/0250079 A1
(43) Pub. Date: Aug. 27, 2026

(54) PRODUCTION LINE AND LOADING APPARATUS

(71) Applicant: Delta Electronics, Inc., Taoyuan City (TW)

(72) Inventors: Yao-Nan SU, Taoyuan City (TW); Chung-Nan CHEN, Taoyuan City (TW)

(21) Appl. No.: 19/233,140

(22) Filed: Jun. 10, 2025

(30) Foreign Application Priority Data
Feb. 27, 2025 (CN) 202510223573.9

(51) Int. Cl. B65G 47/52

(52) U.S. Cl. CPC B65G 47/52

(57) ABSTRACT

The loading apparatus includes a first platform, a conveying mechanism and a pushing mechanism. The first platform has a feeding end and a discharging end, and the first platform is configured to support a carrier. The conveying mechanism is disposed on the first platform and has a feeding assembly and a discharging assembly, which are respectively disposed at the feeding end and the discharging end. The pushing mechanism corresponds to the feeding end. When a material component enters the feeding end, the feeding assembly drives the material component into the carrier, and the push mechanism selectively drives the material component to be accommodated in the carrier, or it drives the material component to the discharging assembly to leave the carrier.

### CROSS REFERENCE TO RELATED APPLICATIONS

This application claims the benefit of China Patent Application No. CN202510223573.9, filed on Feb. 27, 2025, the entirety of which is incorporated by reference herein.

### BACKGROUND OF THE INVENTION

### Field of the Disclosure

The present disclosure relates to a production line and a loading apparatus, and in particular it relates to a loading apparatus that can increase the production efficiency of a production line.

### Description of the Related Art

With the development of technology, various electronic products have already become quite welcomed by people. These electronic products are generally manufactured by production lines in factories. In one production line, multiple machines can serve as multiple stations, and at each station, different manufacturing processes can be performed.

However, during the process of production, some material components may generate defects when being manufactured at a certain station, causing this material component to be unable to become a nonconforming product. Using existing technologies, in this situation, it is necessary to wait for factory equipment personnel to stop the machine at this station and remove this nonconforming material component, and then place another new material component for production. Such a method causes the whole production line to be suspended for a period of time, greatly reducing production efficiency.

Therefore, how to design a loading apparatus that does not create a need to stop the machine to remove the material component and that can be applied to various production lines are topics nowadays that need to be discussed and solved.

### BRIEF SUMMARY OF THE INVENTION

Accordingly, one objective of the present disclosure is to provide a loading apparatus to solve the above problems.

According to some embodiments of the disclosure, a loading apparatus is provided. The loading apparatus includes a first platform, a conveying mechanism and a pushing mechanism. The first platform has a feeding end and a discharging end, and the first platform is configured to support a carrier. The conveying mechanism is disposed on the first platform and has a feeding assembly and a discharging assembly, which are respectively disposed at the feeding end and the discharging end. The pushing mechanism corresponds to the feeding end. When a material component enters the feeding end, the feeding assembly drives the material component into the carrier, and the push mechanism selectively drives the material component to be accommodated in the carrier, or drives the material component to the discharging assembly to leave the carrier.

According to some embodiments, the carrier has a plurality of accommodation grooves, and the loading apparatus further includes a first lifting mechanism which is configured to drive the first platform to move along a first direction, so as to drive one of the accommodation grooves to be aligned with the material component.

According to some embodiments, the feeding assembly includes at least one first roller and at least one first driving motor, and the at least one first driving motor is configured to drive the at least one first roller to drive the material component to move into the carrier.

According to some embodiments, the discharging assembly includes at least one second roller and at least one second driving motor, and the at least one second driving motor is configured to drive the at least one second roller to drive the material component to leave the carrier.

According to some embodiments, the first roller and the second roller are made of a first elastic material.

According to some embodiments, the pushing mechanism includes a first pushing rod and a first driving motor, and the first driving motor is configured to drive the first pushing rod to move along the first direction and rotate around the first direction.

According to some embodiments, the pushing mechanism further includes a second pushing rod and a second driving motor, and the second driving motor is configured to drive the second pushing rod to move along the first direction and rotate around the first direction.

According to some embodiments, the first pushing rod has a long strip-shaped structure, the second pushing rod has a long strip-shaped structure, and the length of the first pushing rod is greater than the length of the second pushing rod.

According to some embodiments, the first pushing rod has a first contact portion which is configured to contact the material component, and when viewed along the first direction, the first contact portion has an arc-shaped structure.

According to some embodiments, the second pushing rod has a second contact portion which is configured to contact the material component, and when viewed along the first direction, the second contact portion has an arc-shaped structure, wherein the first contact portion and the second contact portion are made of a second elastic material.

According to some embodiments, the material component is transferred from a first machine which is located before the loading apparatus, and when the loading apparatus determines that the material component meets a qualification standard according to a notification signal transmitted by the first machine, the loading apparatus controls the first pushing rod to push the material component to the discharging assembly, and then the material component is transferred to a second machine.

According to some embodiments, the material component is transmitted from a first machine which is located before the loading apparatus, and when the loading apparatus determines that the material component does not meet a qualification standard according to a notification signal transmitted by the first machine, the loading apparatus controls the second pushing rod to push the material component to move to be stored in the carrier.

According to some embodiments, the loading apparatus further includes a plurality of unloading rollers which are disposed on the first platform, and the unloading rollers are configured to drive the carrier to separate from the first platform.

According to some embodiments, the loading apparatus further includes a base, the first lifting mechanism and the pushing mechanism are disposed on the base, the first lifting mechanism includes two guiding rods and a first telescopic cylinder, the guiding rods are connected between the first platform and the base, and the first telescopic cylinder is configured to drive the first platform to move along the first direction.

According to some embodiments, the loading apparatus is disposed between a first machine and a second machine, and the loading apparatus further includes a transmission mechanism which is disposed on the first platform, wherein when the first platform is not provided with the carrier, the transmission mechanism is configured to drive the material component to be transferred from the first machine to the second machine.

According to some embodiments, the loading apparatus further includes a second lifting mechanism which is disposed in the first platform, and the second lifting mechanism is configured to drive the transmission mechanism to extend out from the first platform, so as to be aligned with the feeding end.

According to some embodiments, the second lifting mechanism includes a second telescopic cylinder, the second telescopic cylinder is connected between a second platform of the transmission mechanism and the first platform, and the second telescopic cylinder is configured to drive the second platform to move along the first direction.

According to some embodiments, the transmission mechanism further includes at least one conveyor belt and at least one transmission motor, and the at least one transmission motor is configured to drive the at least one conveyor belt to drive the material component to be transferred from the feeding assembly to the discharging assembly.

According to some embodiments of the disclosure, a production line is provided and includes a first machine, a second machine and the loading apparatus as described before. The loading apparatus is disposed before the first machine, between the first machine and the second machine, or after the second machine.

According to some embodiments, when the loading apparatus is disposed before the first machine, the loading apparatus serves as a feeding machine, and when the loading apparatus is disposed after the second machine, the loading apparatus serves as a discharging machine.

The present disclosure provides a loading apparatus, including a conveying mechanism, a first platform and a pushing mechanism. The conveying mechanism is disposed on the first platform and includes a feeding assembly and a discharging assembly, which are respectively located at a feeding end and a discharging end to drive a material component. When the material component enters the carrier, the pushing mechanism can selectively drive the material component to be accommodated in the carrier or drives the material component to the discharging assembly to leave the carrier.

Furthermore, the loading apparatus further includes a first lifting mechanism which is configured to drive the first platform to move along the first direction relative to the base, so as to drive one of the accommodation grooves of the carrier to be aligned with the material component. Based on such a configuration, when an unqualified material component is found, it can be quickly stored in the carrier without affecting the delivery of the next material component.

For example, after the unqualified material component is stored in one of the accommodation grooves of the carrier, the first lifting mechanism can operate to help another empty accommodation groove to be aligned with the next qualified material component, so that the qualified material component can be transferred to the next machine through the carrier. Therefore, the production line can continue to operate without having to shut down the entire production line due to a problem with a single material component. Based on such a design, the overall production efficiency can be increased and the time for removing the unqualified material component can be saved.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a production line 10 according to an embodiment of the present disclosure.

FIG. 2 is a stereoscopic diagram of a loading apparatus 100 according to an embodiment of the present disclosure.

FIG. 3 is a stereoscopic diagram of the loading apparatus 100 in another viewing angle according to an embodiment of the present disclosure.

FIG. 4A to FIG. 4C are top views illustrating that the material component 50 is located in different positions according to an embodiment of the present disclosure.

FIG. 5 is a schematic diagram illustrating that the pushing mechanism 114 pushes the material component 50 according to an embodiment of the present disclosure.

FIG. 6A to FIG. 6C are top views illustrating that the material component 50 is located in different positions according to an embodiment of the present disclosure.

FIG. 7 is a schematic diagram illustrating that the second pushing rod 1143 pushes the material component 50 according to an embodiment of the present disclosure.

FIG. 8 is a schematic diagram illustrating that the first platform 108 moves downward along the first direction AX1 according to an embodiment of the present disclosure.

FIG. 9 is a top view illustrating that the loading apparatus 100 unloads the carrier 103 according to an embodiment of the present disclosure.

FIG. 10 is a three-dimensional diagram of the loading apparatus 100 after unloading the carrier 103 according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

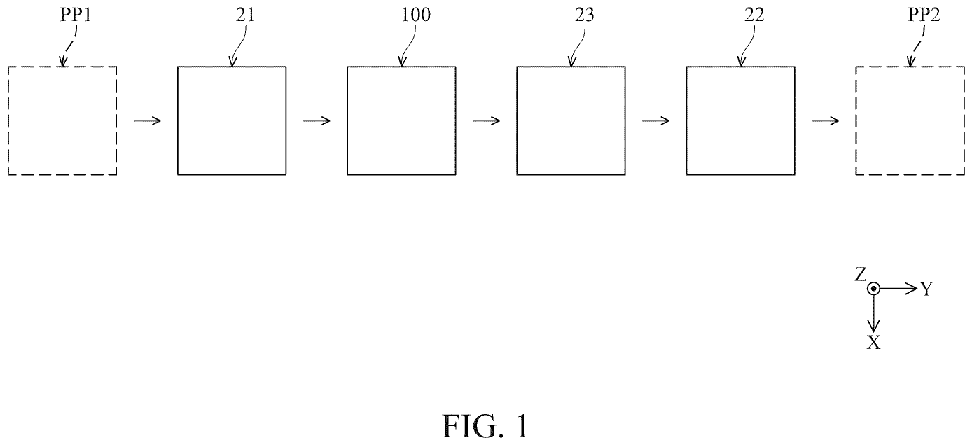

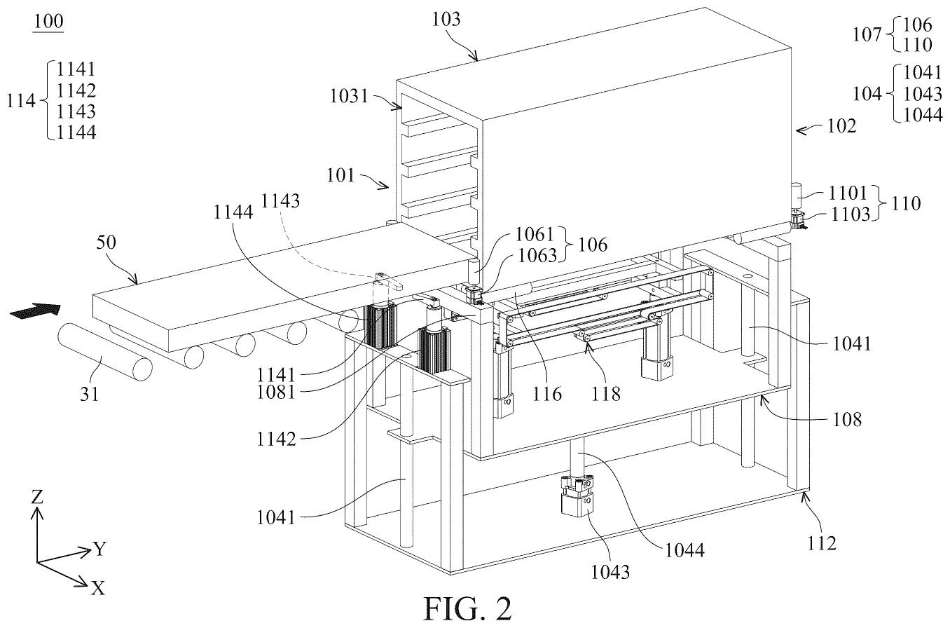

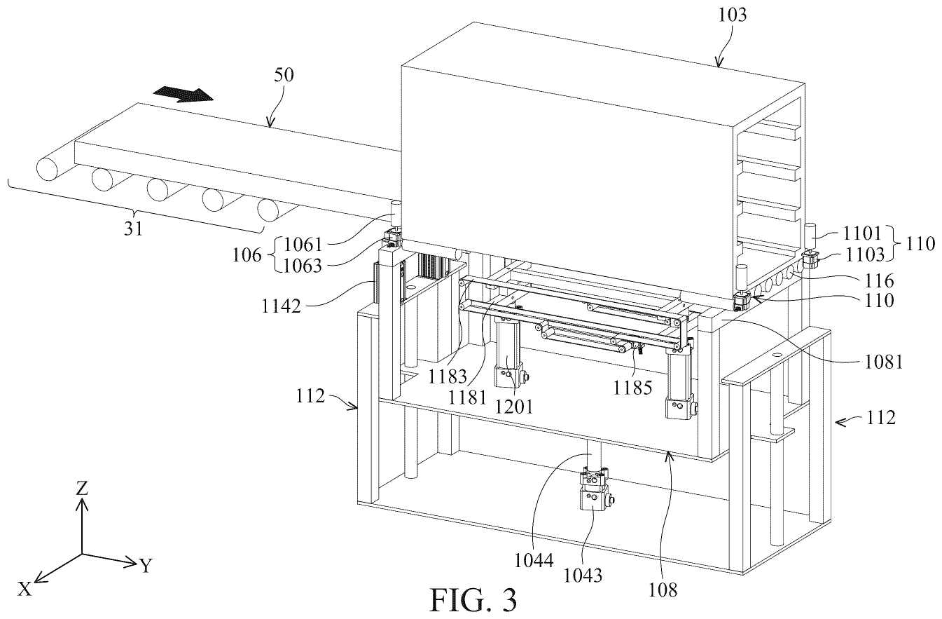

Please refer to FIG. 1 to FIG. 3. FIG. 1 is a schematic diagram of a production line 10 according to an embodiment of the present disclosure, FIG. 2 is a stereoscopic diagram of a loading apparatus 100 according to an embodiment of the present disclosure, and FIG. 3 is a stereoscopic diagram of the loading apparatus 100 in another viewing angle according to an embodiment of the present disclosure. As shown in FIG. 1, the production line 10 can be constructed by a plurality of machines, and the material component is input from the feeding station PP1, passes through a plurality of stations (machines) of different processes, and then to be taken out from the discharging station PP2 after the production is completed.

In this embodiment, the production line 10 may include a first machine 21, a second machine 22, a third machine 23 and a loading apparatus 100, and the loading apparatus 100 is disposed between the first machine 21 and the second machine 22. Specifically, as shown in FIG. 1, the loading apparatus 100 is disposed between the first machine 21 and the third machine 23, but the installation position of the loading apparatus 100 is not limited thereto. In other embodiments, the loading apparatus 100 may also be disposed between the second machine 22 and the third machine 23, disposed before the first machine 21 (at the position of the feeding station PP1) or after the second machine 22 (at the position of the discharging station PP2).

That is, the position of loading apparatus 100 can be adjusted according to actual needs without affecting the operation of the entire production line. For example, when the loading apparatus 100 is disposed on the position of the feeding station PP1, it can serve as a feeding machine, and when the loading apparatus 100 is disposed on the position of the discharging station PP2, it can serve as a discharging machine.

Based on such a configuration, the same loading apparatus 100 can be used to replace the feeding machine and/or the discharging machine, thereby reducing the overall production cost (since the loading apparatus 100 can be manufactured using the same mold). It should also be noted that the number of machines is not limited to this embodiment and may be increased or decreased according to actual demand, and a plurality of loading apparatus 100 may also be disposed in the production line 10.

As shown in FIG. 2 and FIG. 3, the loading apparatus 100 may include a conveying mechanism 107, a first platform 108, and a pushing mechanism 114. The first platform 108 may have a feeding end 101 and a discharging end 102, and the first platform 108 is configured to hold a carrier 103. A material component 50 for production can be transported from a previous station (such as the first machine 21) to a feeding end 101 along the direction of the arrow by a plurality of rollers 31 (or a conveyor belt, not shown in the figures).

The conveying mechanism 107 is fixedly disposed on the first platform 108, and the conveying mechanism 107 may include a feeding assembly 106 and a discharging assembly 110, which are disposed at the feeding end 101 and the discharging end 102, respectively. Specifically, the feeding assembly 106 may include two first rollers 1061 and two first driving motors 1063. The first driving motors 1063 are disposed on a fixed support frame 1081 of the first platform 108 and are configured to respectively drive the first rollers 1061 to rotate so as to drive the material component 50 to enter the carrier 103.

Correspondingly, the discharging assembly 110 may include two second rollers 1101 and two second driving motors 1103. The second driving motors 1103 are disposed on the fixed support frame 1081 of the first platform 108 and are configured to respectively drive the second rollers 1101 to rotate so as to drive the material component 50 to leave the carrier 103.

In this embodiment, the first rollers 1061 and the second rollers 1101 are made of a first elastic material. The first elastic material is, for example, rubber or PU plastic, but they are not limited thereto.

Furthermore, as shown in FIG. 2 and FIG. 3, the loading apparatus 100 may include a base 112, and the pushing mechanism 114 corresponds to the feeding end 101 and is disposed on the base 112. When the material component 50 is driven by the rollers 31 and enters the feeding end 101, the feeding assembly 106 can drive the material component 50 to move into the carrier 103, and the pushing mechanism 114 can selectively drive the material component 50 to be accommodated in the carrier 103 or drive the material component 50 to move to the discharging assembly 110 so as to leave the carrier 103 to the next machine (through another rollers or conveyor belt).

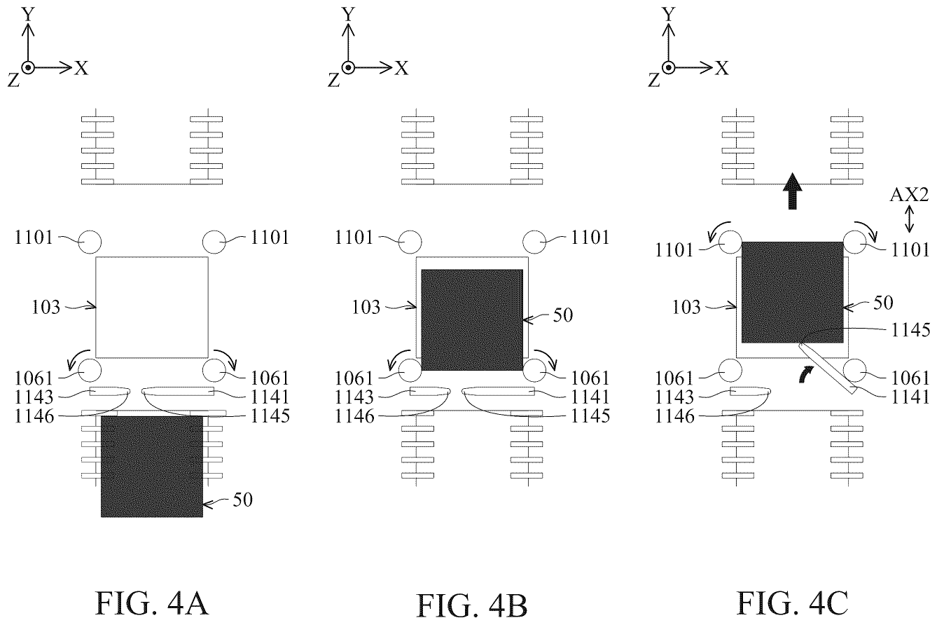

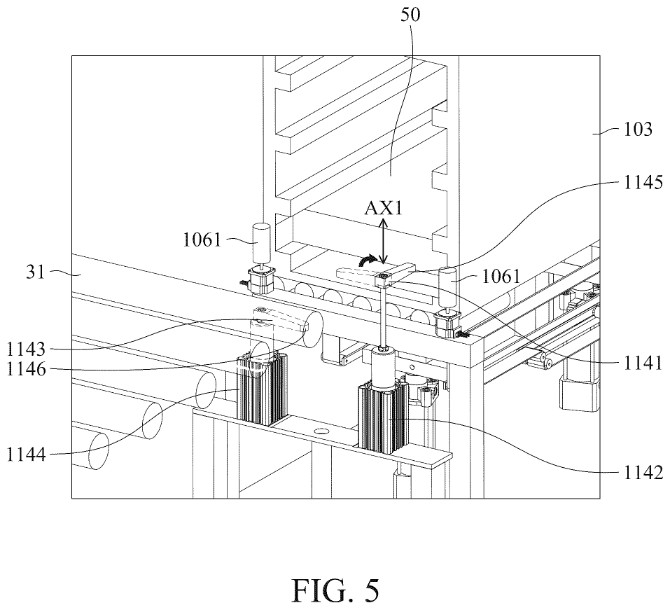

Specifically, please refer to FIG. 2, FIG. 4A to FIG. 4C, and FIG. 5. FIG. 4A to FIG. 4C are top views illustrating that the material component 50 is located in different positions according to an embodiment of the present disclosure, and FIG. 5 is a schematic diagram illustrating that the pushing mechanism 114 pushes the material component 50 according to an embodiment of the present disclosure. As shown in FIG. 2 and FIG. 5, the pushing mechanism 114 may include a first pushing rod 1141 and a first driving motor 1142, and the first driving motor 1142 is configured to drive the first pushing rod 1141 to move along a first direction AX1 (the Z-axis) and rotate around the first direction AX1 (an axis).

Similarly, the pushing mechanism 114 may further include a second pushing rod 1143 and a second driving motor 1144, and the second driving motor 1144 is configured to drive the second pushing rod 1143 to move along the first direction AX1 and rotate around the first direction AX1.

When viewed along the first direction AX1, the first pushing rod 1141 may have a long strip-shaped structure, the second pushing rod 1143 may have a long strip-shaped structure, and the length of the first pushing rod 1141 is greater than the length of the second pushing rod 1143.

The first pushing rod 1141 has a first contact portion 1145 which is configured to contact the material component 50, and when viewed along the first direction AX1, the first contact portion 1145 has an arc-shaped structure.

Similarly, the second pushing rod 1143 has a second contact portion 1146 which is configured to contact the material component 50, and when viewed along the first direction AX1, the second contact portion 1146 has an arc-shaped structure. The first contact portion 1145 and the second contact portion 1146 may be made of a second elastic material, and the second elastic material may be the same as or different from the first elastic material, such as rubber material, but they are not limited thereto.

As shown in FIG. 4A, the material component 50 is transferred from a machine (the first machine 21) which is located before the loading apparatus 100, and the loading apparatus 100 receives a notification signal transmitted by the first machine 21.

When the loading apparatus 100 determines that the material component 50 meets a qualification standard according to the notification signal, and as shown in FIG. 4B, when the first rollers 1061 drive the material component 50 to move into carrier 103, the loading apparatus 100 controls the first pushing rod 1141 to move along the first direction AX1 (as shown in FIG. 5, lifting upward).

Then, as shown in FIG. 4C and FIG. 5, the first pushing rod 1141 rotates around the first direction AX1 to push the material component 50 to move along a second direction AX2 to the discharging assembly 110. Then, the second rollers 1101 of the discharging assembly 110 drive the material component 50 to be transferred to the subsequent machine (such as the second machine 22). The second direction AX2 is perpendicular to the first direction AX1.

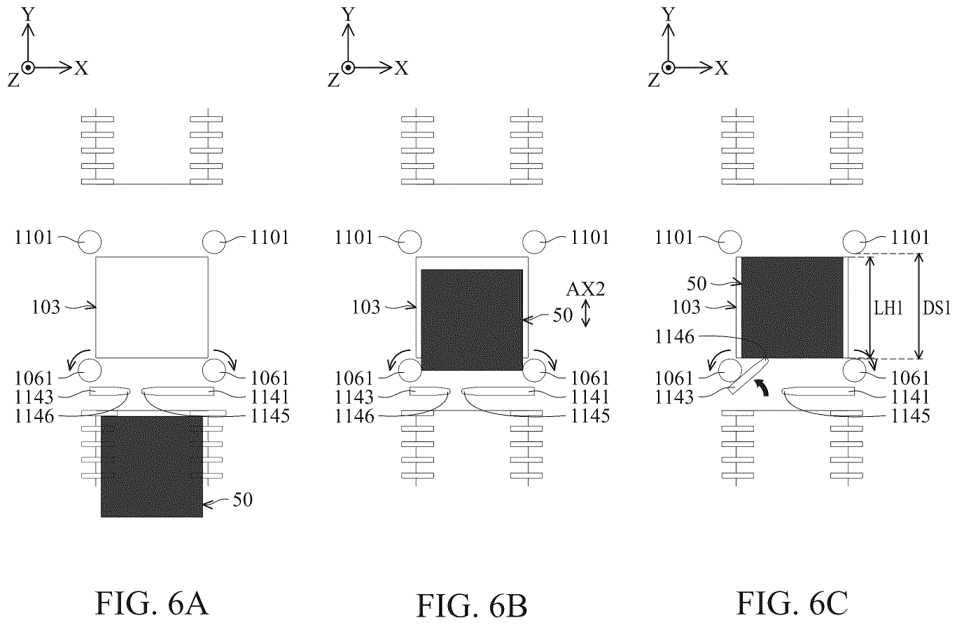

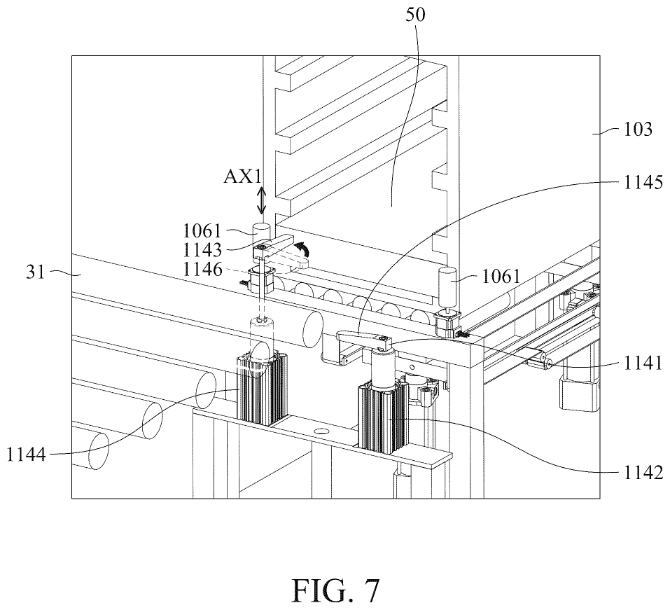

On the other hand, please refer to FIG. 6A to FIG. 6C and FIG. 7. FIG. 6A to FIG. 6C are top views illustrating that the material component 50 is located in different positions according to an embodiment of the present disclosure, and FIG. 7 is a schematic diagram illustrating that the second pushing rod 1143 pushes the material component 50 according to an embodiment of the present disclosure. Similarly, as shown in FIG. 6A, the material component 50 is transferred from the first machine 21 located before the loading apparatus 100, and the loading apparatus 100 receives the notification signal transmitted by the first machine 21.

When the loading apparatus 100 determined that the material component 50 does not meet the aforementioned qualification standard according to the notification signal, the loading apparatus 100 controls the second pushing rod 1143 to move along the first direction AX1 (as shown in FIG. 7, lifting upward), and then as shown in FIG. 6C, the second pushing rod 1143 rotates around the first direction AX1 to push the material component 50 to move along the second direction AX2 to be stored in the carrier 103.

It is worth noting that in this embodiment, the distance DS1 between the feeding assembly 106 and the discharging assembly 110 is greater than the length LH1 of the material component 50. Therefore, based on this design, the pushing mechanism 114 can be used to determine whether the material component 50 is stored in the carrier 103 or to be transferred to the next machine.

It should also be noted that in this embodiment, the machines in the production line 10 and the loading apparatus 100 all adopt the same communication method. For example, the aforementioned notification signal may be transmitted wirelessly via an E84 optical communication sensor, but the method is not limited thereto. Based on such a configuration, no matter where the loading apparatus 100 is disposed in the production line 10, the normal operation of the production line 10 will not be affected.

Furthermore, in some embodiments, the aforementioned notification signal and the monitoring of whether the material component 50 meets the qualification standard can also be transmitted and monitored by a control computer (not shown in the figures). For example, when the material component 50 output by the first machine 21 does not meet the aforementioned qualification standard, the first machine 21 will send a notification signal to the control computer, and then the control computer will control the first machine 21 to store the unqualified material component 50 in the carrier 103.

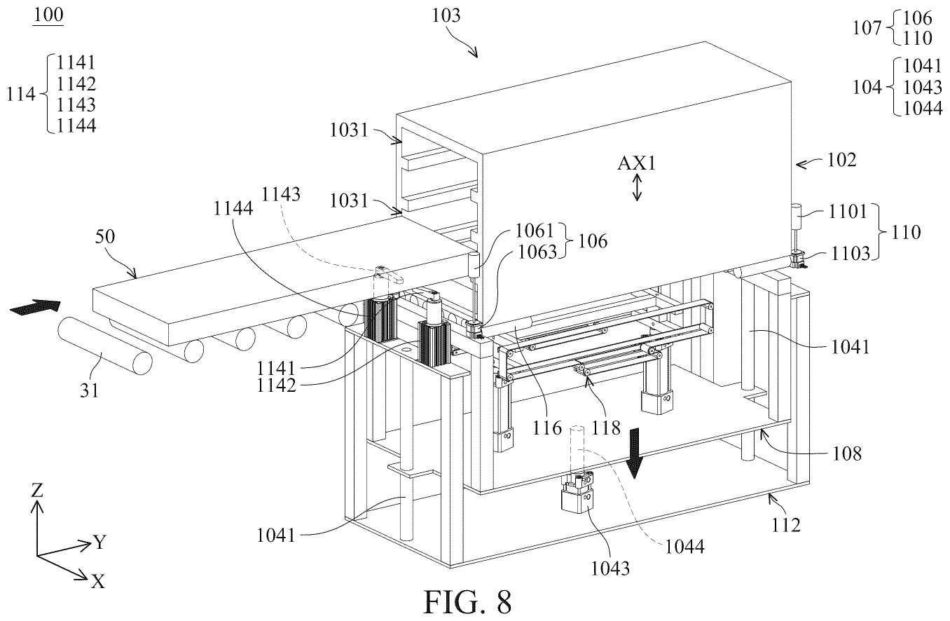

Please refer to FIG. 2 and FIG. 8. FIG. 8 is a schematic diagram illustrating that the first platform 108 moves downward along the first direction AX1 according to an embodiment of the present disclosure. As shown in FIG. 2 and FIG. 8, the carrier 103 has a plurality of accommodation grooves 1031 which are configured to accommodate a plurality of material components 50. In this embodiment, the carrier 103 may have four accommodation grooves 1031, but it is not limited thereto.

]Furthermore, the loading apparatus 100 further includes a first lifting mechanism 104, and the first lifting mechanism 104 is configured to drive the first platform 108 to move along the first direction AX1 relative to the base 112, so as to drive one of the accommodation grooves 1031 to align with the material component 50.

Specifically, the first lifting mechanism 104 is disposed on the base 112, and the first lifting mechanism 104 has two guiding rods 1041 and a first telescopic cylinder 1043. The guiding rods 1041 are connected between the first platform 108 and the base 112, and the first telescopic cylinder 1043 is configured to drive the first platform 108 to move up and down along the first direction AX1. The first telescopic cylinder 1043 may be, for example, an electric cylinder or a servo motor, but it is not limited thereto. Such a configuration can achieve precise movement and positioning.

As shown in FIG. 2 and FIG. 8, the first telescopic cylinder 1043 may have a first telescopic rod 1044, and when a material component 50 is already stored in the lowest accommodation groove 1031 of the carrier 103, the first telescopic cylinder 1043 may drive the first telescopic rod 1044 to retract, so that the first platform 108 moves downward along the direction of the arrow in FIG. 8, so that another accommodation groove 1031 is aligned with another material component 50, and so on.

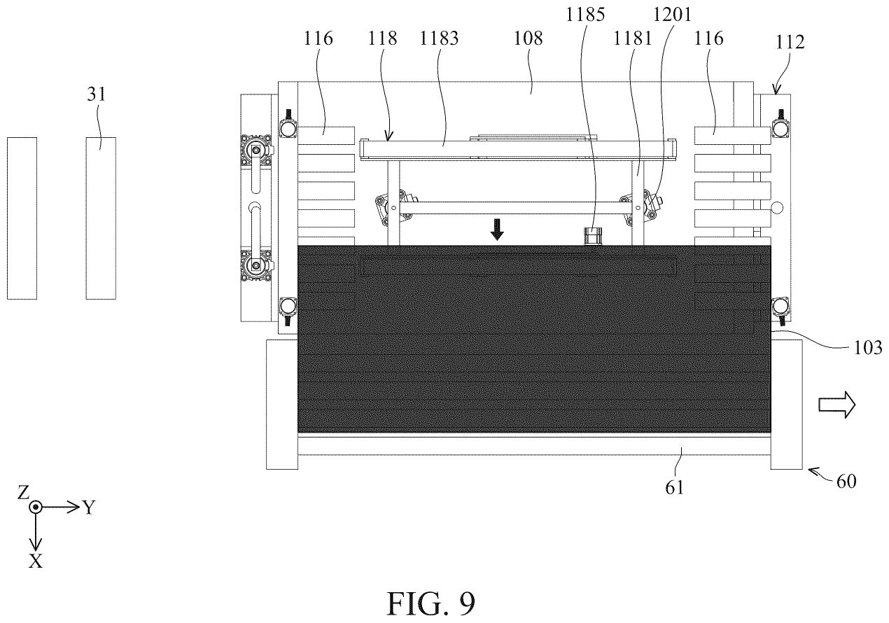

Please refer to FIG. 2 and FIG. 9. FIG. 9 is a top view illustrating that the loading apparatus 100 unloads the carrier 103 according to an embodiment of the present disclosure. In this embodiment, the loading apparatus 100 may further include a plurality of unloading rollers 116 which are disposed on the first platform 108. The unloading rollers 116 may be mounted in a frame (the frame is not shown in the figures to clearly illustrate the unloading rollers 116), and the frame is fixedly mounted on the first platform 108.

When the accommodation grooves 1031 of the carrier 103 are all filled with the material components 50, the unloading rollers 116 can be driven by another driving motor (not shown in the figures) to rotate, so that the carrier 103 moves in the direction of the arrow as shown in FIG. 9 and separates from the first platform 108, and then to be taken over by an automated guided vehicle 60. The automated guided vehicle 60 is provided with a plurality of loading rollers 61 so that the carrier 103 can be smoothly driven and moved onto the automated guided vehicle 60.

The automated guided vehicle 60 may carry these unqualified material components 50 to another station, such as an inspection workstation, and then may carry another empty carrier 103 back to the loading apparatus 100 and load the carrier 103 onto the loading apparatus 100.

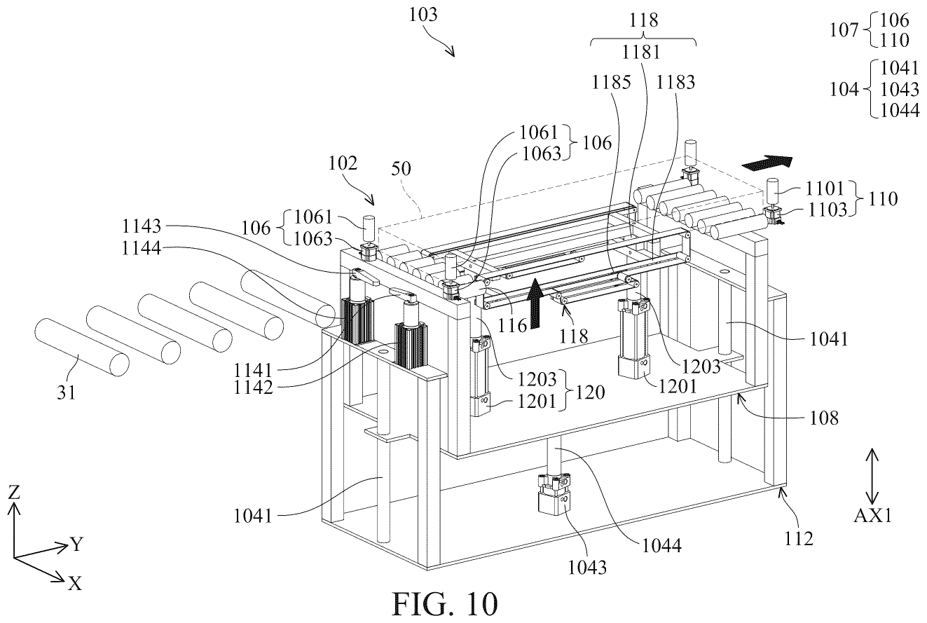

Please refer to FIG. 2, FIG. 9 and FIG. 10. FIG. 10 is a three-dimensional diagram of the loading apparatus 100 after unloading the carrier 103 according to an embodiment of the present disclosure. In this embodiment, the loading apparatus 100 may further include a transmission mechanism 118, which is disposed on the first platform 108, and when the first platform 108 is not provided with the carrier 103, the transmission mechanism 118 is configured to drive the material component 50 from the previous machine (such as the first machine 21) to be transferred to the next machine (such as the third machine 23 or the second machine 22) to ensure that the production line can continue to operate.

Furthermore, the loading apparatus 100 may further include a second lifting mechanism 120 which is disposed in the first platform 108, and the second lifting mechanism 120 is configured to drive the transmission mechanism 118 to extend out from the first platform 108, so as to be aligned with the feeding end 101 and the material component 50.

Specifically, the second lifting mechanism 120 includes two second telescopic cylinders 1201, and the two second telescopic cylinders 1201 are configured to be connected between a second platform 1181 of the transmission mechanism 118 and the first platform 108. In addition, each the second telescopic cylinder 1201 has a second telescopic rod 1203, which is configured to drive the second platform 1181 to move up and down along the first direction AX1. The second telescopic cylinders 1201 may be, for example, electric cylinders or a servo motors, but they are not limited thereto. Such a configuration can achieve precise movement and positioning.

As shown in FIG. 9 and FIG. 10, the transmission mechanism 118 further includes two conveyor belts 1183 and at least one transmission motor 1185. The transmission motor 1185 is configured to drive the conveyor belts 1183 to operate so that the conveyor belts 1183 contact the material component 50 to drive the material component 50 to be transferred from the feeding assembly 106 to the discharging assembly 110, and then transferred to the next machine.

In conclusion, the present disclosure provides a type of loading apparatus 100, including a conveying mechanism 107, a first platform 108 and a pushing mechanism 114. The conveying mechanism 107 is disposed on the first platform 108 and includes a feeding assembly 106 and a discharging assembly 110, which are respectively located at a feeding end 101 and a discharging end 102 to drive a material component 50. When the material component 50 enters the carrier 103, the pushing mechanism 114 can selectively drive the material component 50 to be accommodated in the carrier 103 or drive the material component 50 to the discharging assembly 110 to leave the carrier 103.

Furthermore, the loading apparatus 100 further includes a first lifting mechanism 104 which is configured to drive the first platform 108 to move along the first direction AX1 relative to the base 112, so as to drive one of the accommodation grooves 1031 of the carrier 103 to be aligned with the material component 50. Based on such a configuration, when an unqualified material component 50 is found, the unqualified material component 50 can be quickly stored in the carrier 103 without affecting the delivery of the next material component 50.

For example, after the unqualified material component 50 is stored in one of the accommodation grooves 1031 of the carrier 103, the first lifting mechanism 104 can operate to help another empty accommodation groove 1031 to be aligned with the next qualified material component 50, so that the qualified material component 50 can be transferred to the next machine through the carrier 103. Therefore, the production line 10 can continue to operate without having to shut down the entire production line due to a problem with a single material component 50. Based on such a design, the overall production efficiency can be increased and the time for removing the unqualified material component 50 can be saved.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A loading apparatus, comprising:
a first platform, having a feeding end and a discharging end, wherein the first platform is configured to support a carrier;
a conveying mechanism, disposed on the first platform and having a feeding assembly and a discharging assembly, which are respectively disposed at the feeding end and the discharging end; and
a pushing mechanism, corresponding to the feeding end;
wherein when a material component enters the feeding end, the feeding assembly drives the material component to move into the carrier, and the push mechanism selectively drives the material component to be accommodated in the carrier or drives the material component to the discharging assembly to leave the carrier.

2. The loading apparatus as claimed in claim 1, wherein the carrier has a plurality of accommodation grooves, and the loading apparatus further includes a first lifting mechanism which is configured to drive the first platform to move along a first direction, so as to drive one of the accommodation grooves to be aligned with the material component.

3. The loading apparatus as claimed in claim 2, wherein the feeding assembly includes at least one first roller and at least one first driving motor, and the at least one first driving motor is configured to drive the at least one first roller to drive the material component to move into the carrier.

4. The loading apparatus as claimed in claim 3, wherein the discharging assembly includes at least one second roller and at least one second driving motor, and the at least one second driving motor is configured to drive the at least one second roller to drive the material component to leave the carrier.

5. The loading apparatus as claimed in claim 4, wherein the first roller and the second roller are made of a first elastic material.

6. The loading apparatus as claimed in claim 5, wherein the pushing mechanism includes a first pushing rod and a first driving motor, and the first driving motor is configured to drive the first pushing rod to move along the first direction and rotate around the first direction.

7. The loading apparatus as claimed in claim 6, wherein the pushing mechanism further includes a second pushing rod and a second driving motor, and the second driving motor is configured to drive the second pushing rod to move along the first direction and rotate around the first direction.

8. The loading apparatus as claimed in claim 7, wherein the first pushing rod has a long strip-shaped structure, the second pushing rod has a long strip-shaped structure, and a length of the first pushing rod is greater than a length of the second pushing rod.

9. The loading apparatus as claimed in claim 8, wherein the first pushing rod has a first contact portion which is configured to contact the material component, and when viewed along the first direction, the first contact portion has an arc-shaped structure.

10. The loading apparatus as claimed in claim 9, wherein the second pushing rod has a second contact portion which is configured to contact the material component, and when viewed along the first direction, the second contact portion has an arc-shaped structure, wherein the first contact portion and the second contact portion are made of a second elastic material.

11. The loading apparatus as claimed in claim 8, wherein the material component is transferred from a first machine which is located before the loading apparatus, and when the loading apparatus determines that the material component meets a qualification standard according to a notification signal transmitted by the first machine, the loading apparatus controls the first pushing rod to push the material component to the discharging assembly, and then the material component is transferred to a second machine.

12. The loading apparatus as claimed in claim 8, wherein the material component is transmitted from a first machine which is located before the loading apparatus, and when the loading apparatus determines that the material component does not meet a qualification standard according to a notification signal transmitted by the first machine, the loading apparatus controls the second pushing rod to push the material component to move to be stored in the carrier.

13. The loading apparatus as claimed in claim 12, wherein the loading apparatus further includes a plurality of unloading rollers which are disposed on the first platform, and the unloading rollers are configured to drive the carrier to separate from the first platform.

14. The loading apparatus as claimed in claim 2, wherein the loading apparatus further includes a base, the first lifting mechanism and the pushing mechanism are disposed on the base, the first lifting mechanism includes two guiding rods and a first telescopic cylinder, the guiding rods are connected between the first platform and the base, and the first telescopic cylinder is configured to drive the first platform to move along the first direction.

15. The loading apparatus as claimed in claim 14, wherein the loading apparatus is disposed between a first machine and a second machine, and the loading apparatus further includes a transmission mechanism which is disposed on the first platform, wherein when the first platform is not provided with the carrier, the transmission mechanism is configured to drive the material component to be transferred from the first machine to the second machine.

16. The loading apparatus as claimed in claim 15, wherein the loading apparatus further includes a second lifting mechanism which is disposed in the first platform, and the second lifting mechanism is configured to drive the transmission mechanism to extend out from the first platform, so as to be aligned with the feeding end.

17. The loading apparatus as claimed in claim 16, wherein the second lifting mechanism includes a second telescopic cylinder, the second telescopic cylinder is connected between a second platform of the transmission mechanism and the first platform, and the second telescopic cylinder is configured to drive the second platform to move along the first direction.

18. The loading apparatus as claimed in claim 17, wherein the transmission mechanism further includes at least one conveyor belt and at least one transmission motor, and the at least one transmission motor is configured to drive the at least one conveyor belt to drive the material component to be transferred from the feeding assembly to the discharging assembly.

19. A production line, comprising:
a first machine;
a second machine; and
a loading apparatus as claimed in claim 1, disposed before the first machine, between the first machine and the second machine, or after the second machine.

20. The production line as claimed in claim 19, wherein when the loading apparatus is disposed before the first machine, the loading apparatus serves as a feeding machine, and when the loading apparatus is disposed after the second machine, the loading apparatus serves as a discharging machine.
